(19) United States
(12) Patent Application Publication
(10) Pub. No.: US 2012/0055263 A1
(43) Pub. Date: Mar. 8, 2012

(54) FLOWMETER FOR DETECTING A PROPERTY OF A FLUID MEDIUM

(76) Inventor: Uwe Konzelmann, Asperg (DE)

(21) Appl. No.: 13/226,203

(22) Filed: Sep. 6, 2011

(30) Foreign Application Priority Data
Sep. 8, 2010 (DE) 102010040396.2

(51) Int. Cl. G01F 1/66; G01F 1/34

(52) U.S. Cl. 73/861.18; 73/861.42

(57) ABSTRACT

A flowmeter for detecting at least one property of a fluid medium flowing through a flow tube, in particular a flow property, is described. The flowmeter has at least one ultrasonic sensor for detecting at least one first flow property of the fluid medium. In addition, the flowmeter has at least one differential pressure sensor for detecting at least one second flow property of the fluid medium.

### CROSS REFERENCE

The present application claims the benefit under 35 U.S.C. §119 of German Patent Application No. DE 102010040396.2 filed on Sep. 8, 2010, which is expressly incorporated herein by reference in its entirety.

### BACKGROUND INFORMATION

In many fields of technology and natural sciences, fluid media must be supplied to or removed from a process at a predetermined or controlled rate. For this purpose, flowmeters which are equipped to measure a volume or mass flow of the fluid medium are used in particular. According to the measured flow rate, regulating measures may then be performed, for example. An important field of application, although the present invention is not limited thereto, is the field of air flow measuring in automotive engineering. For example, a quantity of intake air supplied to the combustion process may be measured in the intake tract of an internal combustion engine and adjusted through appropriate regulation such as throttle valves, if necessary.

In addition to the air flow measuring by thermal methods, there has long been the option in automotive engineering and in other industrial fields to measure air quantities, in particular volume flows and/or mass flows in the intake tract, by pressure methods. Examples of flowmeters, in particular the so-called measuring aperture, are described in Robert Bosch GmbH: Sensoren im Kraftfahrzeug [Sensors in the Automobile], 2001 edition, pages 96-103. Other examples of flowmeters include the Prandtl probe or the Pitot probe, which are used in aircraft, for example, to determine the speed of the aircraft. A modern example of a flowmeter known from the related art is the so-called delta flow dynamic pressure probe from the company Systec Controls in Puchheim, Germany. Other air flowmeters are described, for example, in Robert Bosch GmbH: Sensor im Kraftfahrzeug, 2007 edition, pages 86-91.

Many sensors for air flow measuring in an automobile operate according to the so-called Bernoulli principle. Examples of such sensors are described in German Patent Application No. DE 10 2007 023 163. Air flowmeters according to the Bernoulli principle are based on the basic principle that the flow cross section of a flow tube is constricted locally from an original cross section A1 to a smaller cross section A2 by an interfering element. The air volume flow or air mass flow is measured by measuring pressure p1 or p2 upstream and downstream from the interfering element and determining the pressure difference from them. For this purpose a first measuring point is placed in the unconstricted area, and a second measuring point is placed in the constricted area. The volume flow or mass flow is calculated analytically or determined empirically from measured pressure difference Δp using the following equation:

Δp=Qᵥ²·ρ·(1/A₂²−1/A₁²)

where Qv denotes the volume flow of air or of the fluid medium, ρ denotes the density (which is assumed to be constant here) and A1 and A2 denote the constricted and unconstricted cross sections, respectively. For converting the volume flow into a mass flow or vice-versa or for improving the accuracy of the results, a measuring of an absolute pressure or a temperature may additionally be performed, from which the density of the fluid medium may be determined. However, the devices operating according to the Bernoulli principle or other differential pressure measuring principles have substantial dynamic errors in particular at low air flows or when air flow rates vary greatly.

Ultrasonic measuring principles which ensure very precise measurements in certain flow rate ranges are therefore often used for low air flow rates. These ultrasonic flowmeters (USF) measure the velocity of a flowing medium (gas, liquid) with the aid of acoustic waves. These flow measuring devices have at least one sensor which combines the function of a sonic wave transmitter as well as that of a sonic wave receiver. The acoustic flow measuring offers a few advantages in comparison with other measuring methods. The measuring is largely independent of the properties of the media used such as electrical conductivity, density, temperature, and viscosity. The lack of moving mechanical parts reduces maintenance effort and there is no pressure drop due to the constriction in the cross section. The disadvantage of these methods is that they each have a restricted range in which they are able to measure the mass flow or volume flow of a flowing medium precisely enough, but if a large flow range is to be covered, and high dynamics of changes in velocity of flow may also be detected in the entire measuring range, then the individual measuring principles have a high measuring inaccuracy either in the high or low flow range.

A flowmeter, which at least mostly avoids the above-described disadvantages, would therefore be desirable. The flowmeter should in particular be usable in a broad measuring range for measuring volume flows and/or mass flows for fluid media and should also be usable for high flow rates.

### SUMMARY

In accordance with the present invention, the dynamic errors described here for devices operating according to the differential pressure principle may be prevented or at least reduced by using at least one additional measuring principle, which is independent of the properties of the medium. To detect a large throughput range, therefore at least two measuring principles, an ultrasonic measuring principle and a differential pressure measuring principle are combined. The ultrasonic measuring principle may be used in particular to detect a low throughput range and thus in particular small flow rates. On the other hand, the differential pressure principle may be used for a high throughput range in particular and consequently for high flow quantities. It is therefore possible to combine two measuring principles which are relatively insensitive with respect to contamination with foreign bodies, for example, dust, particles, dirty water and oil, so that measuring ranges which are otherwise achievable only with thermal flowmeters are achieved.

A flowmeter for detecting at least one property of a fluid medium flowing through a flow tube is therefore proposed. The at least one property may be in particular at least one flow property. The flowmeter has at least one ultrasonic sensor for detecting at least one first flow property of the fluid medium. The flowmeter also has at least one differential pressure sensor for detecting at least one second flow property of the fluid medium. The at least one property of the fluid medium may fundamentally include any physical and/or chemical property of the fluid medium and/or the flow of the fluid medium. The at least one property of the fluid medium may be ascertainable by using the first flow property and/or the second flow property. For example, the at least one property may be the first flow property, the second flow property or a combination of the first and second flow properties. The at least one flow property of the fluid medium may include in particular at least one flow property of the fluid medium. A flow property is understood within the scope of the present invention to be fundamentally any property which characterizes the flow of the fluid medium in any way. For example, the flow property may include one or more of the following measured variables: a velocity of flow, a mass flow of the fluid medium, a volume flow of the fluid medium. Alternatively or additionally, the at least one property of the fluid medium may also include properties such as a density and/or a temperature of the fluid medium. Any combinations of the aforementioned properties and/or other properties are also possible. The fluid medium may be a gas and/or a liquid or a mixture of both physical states. The fluid medium should be suitable for flowing through the flow tube, for example, within a pumping and/or suction operation.

Fundamentally, any hollow space suitable for receiving the fluid medium without bringing the medium in contact with the outside world may be used as the flow tube. The flow tube may be designed to be closed or partially open.

The flow tube preferably has an elongated shape to connect at least two locations between which the medium is to be exchanged. It may assume any shapes and/or cross sections, for example, circular, round or polygonal cross sections. The flow tube may be designed to be straight-line but may also have curves. In exchanging the fluid medium from one location to the other in the flow tube, the fluid medium preferably moves in one main direction of flow. A main direction of flow is understood to be a local main direction of flow of the fluid medium, for example, a main direction of flow at the site of the measuring. This main direction of flow may of course change, for example, due to corresponding bends in the flow tube.

An ultrasonic sensor is understood to be a sensor element having at least one ultrasonic transducer, preferably at least two ultrasonic transducers. In addition, the ultrasonic sensor may include, for example, additional elements, in particular at least one reflective surface equipped for reflecting ultrasonic waves. An ultrasonic transducer is understood to be an acoustic-electrical transducer element suitable for emitting and/or detecting ultrasonic waves. Examples of ultrasonic transducers include piezoelectric transducer elements. Fundamentally stand-alone ultrasonic sensors of this type are conventional. For example, the flowmeter may have ultrasonic transducers which are situated relative to one another across the main direction of flow, so that they are able to exchange ultrasonic waves with one another, these waves having at least one velocity component parallel to the main direction of flow of the fluid medium. For example, the ultrasonic transducers may emit ultrasonic waves obliquely into or against the main direction of flow into the flow tube and/or may detect ultrasonic waves. The ultrasonic waves may move through the fluid medium and may strike at least one reflective surface, for example, which may be mounted in the flow tube. Alternatively or additionally, at least one reflective surface of the ultrasonic sensor may be formed by the flow tube itself, in that the inside of the tube functions as the reflective surface for the waves. One example of a velocity measuring using ultrasonic waves is the transit time difference measuring. For this measuring method, the fluid medium should be as homogeneous as possible and should have only a low solids content, as is the case with pure gases, pure liquids and gas-liquid mixtures. For example, at least two sensors may be situated at different points in the main direction of flow, but it does not matter whether the sensors are situated on the same side of the flow tube or on different sides because the acoustic waves of the ultrasonic signal are able to propagate in all directions. This means that the signal of the one ultrasonic transducer propagating with the main direction of flow arrives at the second ultrasonic transducer more quickly than the signal of the ultrasonic transducer located downstream because the ultrasonic waves of the latter propagate more slowly against the main direction of flow. An ultrasonic wave propagates more rapidly in the direction of flow of the fluid medium than ultrasonic waves in the opposite direction. The transit times may be measured continuously or discontinuously. The transit time difference between the two ultrasonic waves is thus proportional to the average velocity of flow of the fluid medium. The flow volume per unit of time may be calculated, for example, as the product of the average velocity of flow multiplied by the corresponding tube cross section of the flow tube. In this way, for example, measuring substances may also be identified directly, based on transit time measurements of ultrasonic waves.

The sound propagation time in water, for example, is lower than that in heating oil. The velocity of flow is calculated according to the transit time method using the following equation:

υ=((T₂−T₁)/T₁T₂)*(L/2 cos α)

where:
υ denotes the average velocity of flow of the medium,
T₁ denotes the transit time of the ultrasonic signal with the flow,
T₂ denotes the transit time of the ultrasonic signal against the flow,
L denotes the length of the ultrasonic path, and
α denotes the angle of the ultrasonic signal to the flow.

For media having a high solids content, there is the option of performing ultrasonic measurements on the basis of the Doppler method, for example, in which a frequency shift of the signal emitted is detected on the basis of the velocity of flow of the particles in the medium. Additional methods and configurations of ultrasonic sensors in tube systems have long been known in the related art, as already described above.

In addition, the flowmeter has at least one differential pressure sensor, which may be mounted, for example, on the flow tube and/or in the flow tube and/or may be integrated entirely or partially into the flow tube. The differential pressure sensor is likewise equipped to ascertain at least one flow property, which is designated below as the second flow property. Fundamentally stand-alone differential pressure sensors are also conventional. A differential pressure sensor within the scope of the present invention is understood to be a sensor element for detecting at least one property of the fluid medium, which is based on measuring of at least one pressure and/or use of at least one pressure sensor equipped to detect a pressure of the fluid medium. The differential pressure sensor may be based on static and/or dynamic measuring principles. In particular the differential pressure sensor may be equipped to detect a static and/or dynamic pressure of the fluid medium at least two measuring sites, which are offset relative to one another in the main direction of flow and/or across the main direction of flow. For example, at least two pressure sensors may be provided and/or at least one differential pressure sensor may be provided to detect at least two pressures at the at least two measuring sites and/or to detect a pressure difference between the at least two measuring sites.

The differential pressure sensor may include in particular at least one sensor selected from the group including a Prandtl probe, a Pitot probe, a measuring aperture, a Venturi differential pressure sensor, a differential pressure sensor. In particular the differential pressure sensor may include at least one flow-constricting element, i.e., at least one element equipped to constrict a cross section of the flow tube through which the fluid medium flows. For example, the differential pressure sensor may then be equipped to detect at least two pressures of the fluid medium at different locations in the flow tube having different flow-through cross sections. The flow-constricting element may include in particular at least one aperture equipped to constrict the flow cross section of the flow tube, for example, in a circular or annular form. The at least one aperture may include, for example, at least one fundamentally stand-alone measuring aperture such as that used for conventional pressure measurements.

A preferred specific embodiment is a flowmeter in which the ultrasonic sensor and the differential pressure sensor are positioned essentially in the same position in or on the flow tube, based on the main direction of flow. Differences in position of the ultrasonic sensor, i.e., the differential pressure sensor, are based on the arithmetic mean of the position of the particular sensors in the main direction of flow. “Essentially in the same position” preferably means that the differential pressure sensor is no more than 20 mm away from the ultrasonic sensor in the main direction of flow. For example, the arithmetic mean of two ultrasonic transducers may denote the position of the ultrasonic sensor. With respect to the differential pressure sensor, for example, the arithmetic mean of the positions of at least two pressure sensors, of at two pressure measuring sites and/or an arithmetic mean of the positions of one or more absolute pressure gauges and one or more differential pressure gauges may indicate the position of the differential pressure sensor. The differential pressure sensor and the at least one ultrasonic sensor should be separated from one another by no more than 2 ms with respect to the minimal transit time of the fluid medium in the flow tube to avoid an excessive variance in the measured values of the two sensors. The at least one ultrasonic sensor and the at least one differential pressure sensor may also therefore overlap completely or partially in the direction of flow. For example, one ultrasonic transducer of the ultrasonic sensor may be situated upstream from the differential pressure sensor, while a second ultrasonic transducer of the ultrasonic sensor may be situated downstream from the differential pressure sensor. This achieves the result that the two measuring signals originate from the same location in the flow tube and thus no inaccuracies may occur between the two measuring signals, which could arise because of a different positioning of the sensors. In this way, the two signals of the two sensors may be correlated with one another, so that, for example, measured pressure values ascertained by the differential pressure sensor are combined with measured transit time values of the ultrasonic sensor to determine the density and/or the temperature of the fluid medium, for example.

One example of a flowmeter according to the present invention is a flowmeter having at least two ultrasonic transducers situated in different positions with respect to the main direction of flow. These two ultrasonic transducers may be situated directly next to the at least one differential pressure sensor or may even overlap with the differential pressure sensor, as described above.

The flowmeter is a combination of the at least two sensors, i.e., the at least one ultrasonic sensor and the at least one differential pressure sensor. The differential pressure sensor and the ultrasonic sensor may be designed to be completely separate from one another, but they preferably also have at least one shared component. This component may be, for example, a holder which has and/or carries one or more function elements for the differential pressure sensor as well as one or more function elements for the ultrasonic sensor, for example. Such function elements may constitute an opening for the absolute pressure measuring for the differential pressure sensor, for example. In addition, this holder may connect parts of the differential pressure sensor to one another and/or may additionally have or carry a functional element of the ultrasonic sensor. Alternatively or additionally, the shared component may be, for example, a reflective surface for ultrasonic waves of the ultrasonic sensor or may have such a reflective surface. The ultrasonic sensor may in particular utilize knowledge of the absolute pressure of the fluid medium to determine the mass flow. To this extent, at least one absolute pressure sensor may be integrated directly into the control and analysis electronics of the ultrasonic sensor or be connected to the control and analysis electronics of the ultrasonic sensor. This yields a space-saving sensor based on two different measuring principles.

An additional aspect of the present invention is a method for detecting at least one property of a fluid medium flowing through a flow tube, using a flowmeter according to one of the preceding claims in particular, such that at least one first flow property of the fluid medium is detected by at least one ultrasonic sensor, and at least one second flow property of the fluid medium is detected by at least one differential pressure sensor.

The first flow property may preferably be used to determine the at least one property in at least one first value range and the second flow property may be used to determine the at least one property in at least one second value range. The value ranges may be, for example, quantities or ranges of measured values of the first flow property and/or the second flow property and/or of values derivable from these flow properties. The value ranges may be separated from one another but they may also overlap with one another in at least one transitional range. Thus, for example, in the first value range outside of the transitional range, only the first flow property may be used, in the second value range outside of the transitional range only the second flow property may be used, and a combined property which combines the first flow property and the second flow property may be used in the overlap range. In the transitional range, for example, there may also be an adjustment of characteristic curves of the ultrasonic sensor and of the differential pressure sensor to one another. This may be accomplished, for example, by adjusting one or more calibration values. For example, a characteristic line of the differential pressure sensor may be adjusted to a characteristic curve of the ultrasonic sensor in a transitional range by choosing one or more calibration values or vice-versa, for example, through an appropriate choice of an offset.

By combining the two sensors based on different detection mechanisms, it is possible to perform precise velocity measurements in fluid media having highly dynamic velocities of flow in both the low flow range and the high flow range. For example, measurements may be performed in the range of 1 m/s to 30 m/s using the ultrasonic sensor and measurements in the range of 20 m/s to 60 m/s may be performed using the differential pressure sensor. In addition, a sensor malfunction is detectable by determining a characteristic curve for the behavior of the two sensors in different velocity ranges.

### BRIEF DESCRIPTION OF THE DRAWINGS

Additional details and features of the present invention are derived from the following description of preferred exemplary embodiments, which are illustrated schematically in the figures.

FIG. 1 shows a first exemplary embodiment of a flowmeter in a sectional view parallel to a main direction of flow.

FIGS. 2 and 3 show a second exemplary embodiment of a flowmeter in a sectional view parallel to a main direction of flow (FIG. 2) and in a sectional view perpendicular to the main direction of flow (FIG. 3).

### DETAILED DESCRIPTION OF EXAMPLE EMBODIMENTS

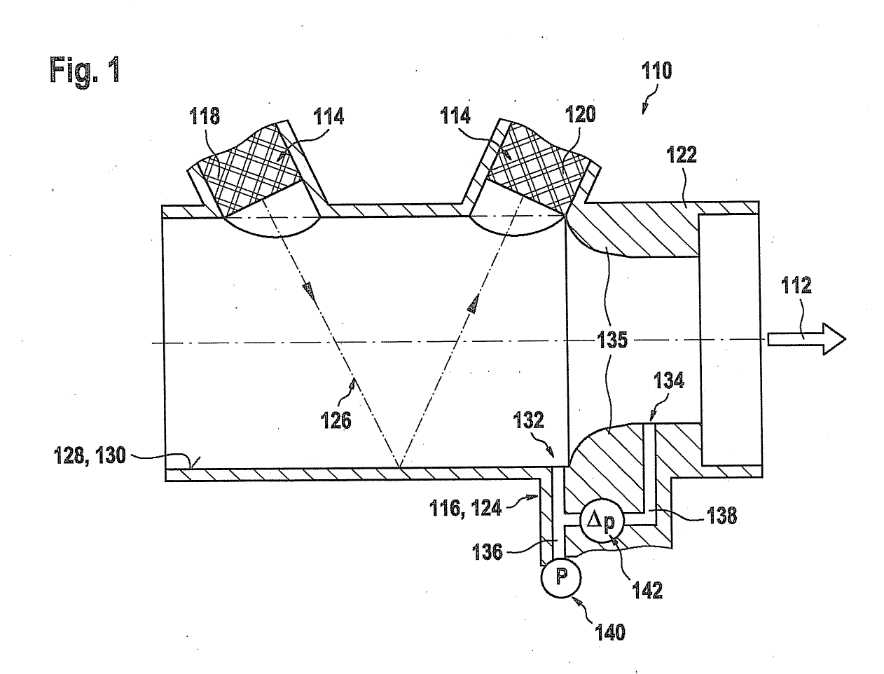

FIG. 1 shows a first exemplary embodiment of a flowmeter 110 according to the present invention in a sectional diagram parallel to a main direction of flow 112 of a fluid medium. Flowmeter 110 includes a combination of at least one ultrasonic sensor 114 and at least one differential pressure sensor 116. Ultrasonic sensor 114 in the exemplary embodiment shown here includes as an example two ultrasonic transducers 118, which may be situated, for example, in a V-shaped design in a wall of a flow tube 122 through which a fluid medium flows in main direction of flow 112. Differential pressure sensor 116 may be embodied, for example, as a Venturi probe 124 and may also be situated in flow tube 122. Alternatively or in addition to Venturi probe 124, differential pressure sensor 116 may include other types of differential pressure sensors, for example, a measuring aperture.

In the exemplary embodiment according to FIG. 1, ultrasonic transducers 118, 120 are situated offset from one another in main direction of flow 112, for example, namely a first ultrasonic transducer 118 upstream from a second ultrasonic transducer 120. Ultrasonic transducers 118, 120 may be equipped to emit and receive ultrasonic waves. Using the configuration from FIG. 1, it is thus possible to emit ultrasonic waves in the direction of main direction of flow 112, as shown in FIG. 1, with the aid of an ultrasonic path 126, for example, and also in an opposite direction, i.e., opposite main direction of flow 112, which is not shown in FIG. 1. The ultrasonic waves strike a reflective surface 128, where they are reflected. In the exemplary embodiment show here, an inside wall 130 of flow tube 122 is provided as reflective surface 128 at the same time as an example. However, other configurations are also possible. For example, it is possible to position ultrasonic transducers 118, 120 on opposite sides of flow tube 122, so that the ultrasonic waves need not be reflected but instead may be exchanged directly between the two ultrasonic transducers 118, 120. In addition, it is possible to design reflective surface 122 separately from inside wall 130 of the tube. In general, configurations having at least one reflective surface 128 are preferred, for example, configurations in which ultrasonic transducers 118, 120 are situated on the same side of flow tube 122, because with these configurations the velocity of flow may usually be determined more precisely because of the longer path distances.

Differential pressure sensor 116 is preferably situated in direct proximity to ultrasonic sensor 114. To ensure the most comparable possible conditions for the measuring results of the two sensors, i.e., of ultrasonic sensor 114 and of differential pressure sensor 116, the distance between both sensors 114 and 116 is preferably kept as small as possible.

Differential pressure sensor 116 shown in FIG. 1 is based on the so-called Venturi principle and consequently has at least two sampling sites or pressure measuring sites 132, 134 in areas of flow tube 122 in which it has different flow cross sections. For example, at least one flow-constricting element 135 may be provided in flow tube 122. Pressure measuring sites 132, 134 may be set up, for example, where tubes 136, 138 end in flow tube 122. Tubes 136, 138 may be situated, for example, across flow tube 122 and may communicate with flow tube 122 and/or with one another. Pressure measuring sites 132, 134 may be used individually or both together for at least one absolute pressure measuring and/or for at least one differential pressure measuring. FIG. 1 shows as an example an embodiment in which tubes 136 are used as a sampling tube for an absolute pressure measuring using an absolute pressure gauge 140. Alternatively or additionally, differential pressure sensor 116 in the exemplary embodiment shown here has at least one differential pressure gauge 142, which is able to perform, for example, a differential pressure measuring between pressure measuring site 132 having a wider flow cross section and downstream pressure measuring site 134 having a smaller flow cross section.

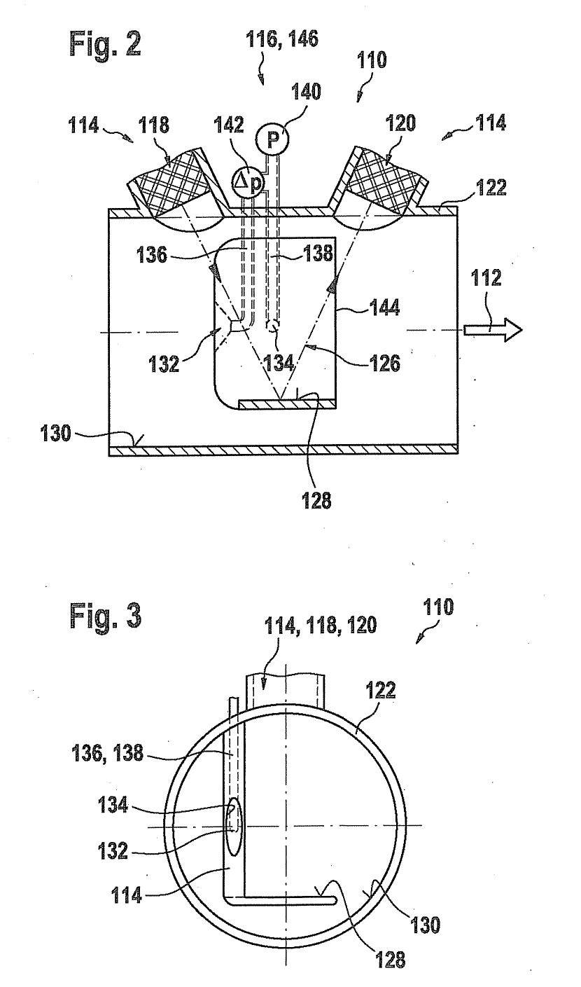

FIGS. 2 and 3 show a second exemplary embodiment of a flowmeter 110 in sectional diagrams parallel to the main direction of flow 112 (FIG. 2) and a sectional diagram perpendicular to the main direction of flow 112 (FIG. 3). Flowmeter 110 according to FIG. 2 has an ultrasonic sensor 114 having two ultrasonic transducers 118, 120, which are situated offset from one another in main direction of flow 112 on the same side of a flow tube 122. An ultrasonic path 126 strikes a reflective surface 128, which in this exemplary embodiment is preferably not situated on a tube inside wall 130 of flow tube 122 but instead is preferably part of a holder 144. This holder 144 may at the same time be part of differential pressure sensor 116 and/or may carry parts thereof. Reflective surface 128 in flow tube 122 is preferably at a suitable distance from ultrasonic transducers 118, 120. Holder 144 preferably connects reflective surface 128 to parts of differential pressure sensor 116.

In this exemplary embodiment or in other exemplary embodiments, differential pressure sensor 116 may be embodied as a Prandtl probe 146 and/or may include a Prandtl probe 146, for example. For this purpose, differential pressure sensor 116 may again have at least two pressure measuring sites 132, 134, for example. An opening facing opposite the main direction of flow 112 in a first tube 136 is provided as first pressure measuring site 132 in holder 144, which may also have an enlargement, for example. First pressure measuring site 132 may thus be a dynamic pressure measuring site, for example. Another opening provided laterally on holder 144 downstream from first measuring site 132 may also be used as second pressure measuring site 134, this opening being designed, for example, as an end of a second tube 138 in the wall of holder 144. Differential pressure sensor 116 may in turn have at least one absolute pressure gauge 140, for example, which may be connected to second tube 138 and/or may have at least one differential pressure gauge 142 to measure a differential pressure between tubes 136 and 138, for example.

To obtain a measuring signal, which is steady over the entire measuring range in the exemplary embodiment in FIG. 1, in the exemplary embodiment in FIGS. 2 and 3 or in other exemplary embodiments according to the present invention, the measuring ranges of at least one ultrasonic sensor 114 and at least one differential pressure sensor 116 may be joined to one another. In this case, as described above, it is possible to utilize the fact that the measuring errors with differential pressure sensors 116 usually involve mainly a zero point drift of differential pressure gauge 142. Joining the measuring ranges and thus determining the value ranges may be accomplished, for example, in the following way, which is described here on the basis of air as a fluid medium, for example.

The air mass may first be ascertained, for example, by at least one ultrasonic sensor 114 (also known as an ultrasonic flowmeter USF):

m_{(USF)}=D_{(USF)}·ρ,

where
m: air mass
D: air flow measured value of the USF (from calibration)
ρ: density of the medium.

Density ρ is furthermore defined by

ρ=ρ_{abs}/R/T

where
p_{abs}: absolute pressure
R: gas constant
T: absolute temperature

The temperature may be determined, for example, from the transit time of the ultrasonic waves and/or by an additional temperature sensor.

The fluid mass is determined by differential pressure sensor 116 (DPS), for example, according to the equation

M_{(DPS)}=C*{square root over (((p+p_{off})·ρ))}

where
C: calibration constant
p: differential pressure
p_{off}: offset
ρ: density of the medium.

Ranges in which the individual signals are used differently may be defined. The following variables may be used:

mₘᵢₙ: minimum media mass flow detectable by at least one ultrasonic sensor 114
m₁: start of transitional range
m₂: end of transitional range
mₘₐₓ: maximum media mass flow detectable by at least one ultrasonic sensor 114.

A possible use of the two sensor principles involves using the ultrasonic sensor in the range from mₘᵢₙ to m₂. In the range from m₂ to mₘₐₓ the differential pressure sensor signal may be used and in the range between m₁ and m₂, p_{off} may be determined by equating m_{(USF)} and m_{(DPS)}.

The p_{off} value may be determined and used in the range between m₂ and mₘₐₓ until again reaching the range between m₁ and m₂. This results in a steady characteristic curve of flowmeter 110. An error status of at least one ultrasonic sensor 114, i.e., at least one differential pressure sensor 116, may be detected by a plausibility check of the p_{off} value.

What is claimed is:

1. A flowmeter for detecting at least one property of a fluid medium flowing through a flow tube, comprising:
at least one ultrasonic sensor to detect at least one first flow property of the fluid medium; and
at least one differential pressure sensor to detect at least one second flow property of the fluid medium.

2. The flowmeter as recited in claim 1, wherein at least one property is selected from: a flow velocity, a mass flow of the fluid medium, a volume flow of the fluid medium, a temperature of the fluid medium, a density of the fluid medium.

3. The flowmeter as recited in claim 1, wherein the differential pressure sensor is a sensor selected from the group including a Prandtl probe, a Pitot probe, a measuring aperture, a Venturi probe, a differential pressure sensor.

4. The flowmeter as recited in claim 1, wherein the differential pressure sensor includes at least one flow-constricting element.

5. The flowmeter as recited in claim 1, wherein the ultrasonic sensor and the differential pressure sensor are positioned essentially in the same position in or on the flow tube, based on a main direction of flow of the fluid medium.

6. The flowmeter as recited in claim 1, wherein the flowmeter has at least two ultrasonic transducers situated in different positions with respect to a main direction of flow of the fluid medium.

7. The flowmeter as recited in claim 1, wherein the differential pressure sensor and the ultrasonic sensor have at least one shared component.

8. The flowmeter as recited in claim 7, wherein the shared component has a reflective surface for ultrasonic waves of the ultrasonic sensor.

9. A method for detecting at least one property of a fluid medium flowing through a flow tube using a flowmeter comprising:
detecting at least one first flow property of the fluid medium by at least one ultrasonic sensor; and
detecting at least one second flow property of the fluid medium by at least one differential pressure sensor.

10. The method as recited in claim 9, wherein the first flow property is used to determine at least one property in at least one first value range and the second flow property is used to determine at least one property in at least one second value range.
